(19) United States
(12) Patent Application Publication
(10) Pub. No.: US 2020/0254672 A1
(43) Pub. Date: Aug. 13, 2020

(54) EXTRUDED ELASTOMER FEATHER-EDGED CRENULATED GRIP TAPES

(71) Applicant: Redwin Rutherby E. GRAHAM-WALSH, PORT SYDNEY (CA)

(72) Inventor: Roger Charles WALSH, BELLEVILLE, ON (CA)

(21) Appl. No.: 16/645,011

(22) PCT Filed: Aug. 28, 2018
(86) PCT No.: PCT/CA2018/051032

§ 371 Date: Mar. 6, 2020

Related U.S. Application Data
(60) Provisional application No. 62/555,346, filed on Sep. 7, 2017.

(51) Int. Cl. B29C 48/00; B29C 48/07; B29C 48/92

(52) U.S. Cl. CPC B29C 48/022; B29C 48/07; B29K 2101/12; B29C 2948/9259; B29C 2948/92704; B29C 48/92

(57) ABSTRACT

A crenulated extruded elastomer tape and a method for producing said extruded elastomer tape is provided, which includes an extruded elastomer tape having crenulated cleavages extending along the width of the tape and the tape having feather-edges. The tape, when attached to an object, increases grip and reduces vibration transfer between the object and a person's hand or hands. The crenulated cleavages may also move relative to the object, but not the person's hand or hands, eliminating kinetic friction on the person's hand or hands Potential uses for the tape may be attaching the tape to sports equipment, tools or walking aides.

### FIELD

This disclosure relates to extruded elastomer feather-edged grip tapes, and more specifically extruded elastomer flat grip tapes or tapes with crenulated cleavages to provide grip in order to reduce the transfer of vibrations and skin irritation

### BACKGROUND

There exists a widespread need to cushion, reduce vibration in body cells, reduce muscle impairment pain and to protect the skin from moving on the griped handle surface thus preventing blistering when using hand and power tools, safety and sports equipment that produce vibrations, such as chainsaws, shovels, canes and baseball bats to mention a few.

One of the major advantages of an elastomer material is its flexibility and ease of fabrication by way of extrusion. However, one of the disadvantages of this is that an extremely uniform product is consistently produced, the uniformity of which diminishes its attraction for many decorative applications. Furthermore, the production of elastomer materials through a die has led to a longitudinally smooth surface, formed in conformity with the die surface. While in many uses this is favorable, in some instances this smooth surface is highly undesirable, as it may be very slippery, when positioned on the ground.

Another problem with a smooth surface is it can transmit vibrations and create friction that results in blistering and a loss of the energy directed towards the task at hand.

### SUMMARY

The present disclosure provides an extruded crenulated elastomer tape and a method for extruding the crenulated tape.

The extruded crenulated elastomer tape comprises a tape composed of an elastomer extruded from a die with feather-edges; the tape having a first side and a second side opposite to the first side; wherein the tape has crenulated cleavages extending along the width of the tape; and wherein the tape has feather-edges with the crenulations extending between the feather-edges.

The elastomer may have a durometer between Shore 35-A and Shore 90-A.

The elastomer may be one of polyurethane, a polyolefin or one of the six generic classes of commercial thermoplastic or thermorubber elastomers.

The crenulated elastomer tape may have small ridges which extend along the width of the tape in the same general direction as said crenulated cleavages of different controlled dimensions

The tape may be curved along the width such that one of said first side and second side is concave and the other of said first side and second side is convex.

The tape may be attached to an object and a person may grip said tape, said person's grip of said object increasing compared to said object without said tape.

The tape may be attached to an object and a person may grip said tape, said tape reducing vibration transfer between said object and said person's hand or hands.

The tape may be attached to an object and a person may grip said tape, said crenulated cleavages not moving relative to said person's hand or hands and said crenulated cleavages moving relative to said object.

The tape may contain phosphorescence or photoluminescence material such that the tape is phosphorescent or photoluminescent.

The phosphorescent material may be alkaline aluminate and rare earth ions.

The tape may contain fluorescent material such that the tape is fluorescent.

The tape may contain reflective particles such that the tape is reflective.

The reflective particles may be aluminum flakes.

The present disclosure provides a method for extruding a crenulated elastomer tape, in which he tape comprises: an elastomer; an extruder able to extrude at least one elastomer; said extruder wherein the speed of extrusion and temperature of extrusion are controllable; a die with a hole able to extrude an elastomer; said hole being shaped to extrude a tape with feather-edges. The method comprising the steps of: extruding the elastomer through the die using the extruder, while controlling the speed of extrusion and temperature of extrusion such that the elastomer vibrates while being extruded such that an elastomer tape is extruded; and wherein the elastomer tape has crenulated cleavages extending along the width of said tape and feather-edges.

The extrusion speed and said extrusion temperature of said extruder and down line take off speed may be controlled such that said extruder extrudes smooth feather-edged tape using the same die and elastomer.

A further understanding of the functional and advantageous aspects of the invention can be realized by reference to the following detailed description and accompanying drawings.

### BRIEF DESCRIPTION OF THE DRAWINGS

The present disclosure will be more fully understood from the following detailed description thereof taken in connection with the accompanying drawings, which form part of this application, and in which:

FIG. 1 is a perspective view of an embodiment of the extruded elastomer grip vibration reducing tape;

FIG. 2 is an end view of the embodiment of the extruded elastomer grip tape of FIG. 1;

FIG. 3 is a top-down view of an embodiment of the extruded elastomer grip tape;

FIG. 4 is a section view of the embodiment of the extruded elastomer grip tape of FIG. 3;

FIG. 5 is a perspective view of an alternate embodiment of the extruded elastomer grip tape;

FIG. 6 is a perspective view of an embodiment of the die used to extruded the extruded elastomer grip tape;

FIG. 7 is a top-down view of an alternate embodiment of the extruded elastomer grip tape;

FIG. 8A is a front view of an embodiment of the extruded elastomer grip tape wrapped around the handle of a baseball bat;

FIG. 8B is a close up view of the embodiment of the extruded elastomer grip tape of FIG. 8A wrapped around the handle of a baseball bat;

FIG. 9 is a perspective view of an embodiment of the extruded elastomer grip tape wrapped around the handle of a shovel;

FIG. 10 is a perspective view of an embodiment of the extruded elastomer grip tape wrapped around a cane;

FIG. 11 is a perspective view of an embodiment of the extruded elastomer grip tape as a keychain;

FIG. 12 is a perspective view of a photoluminescent embodiment of the extruded smooth elastomer feather-edged tape applied to a floor;

FIG. 13 is a perspective view of a photoluminescent embodiment of the extruded smooth elastomer feather-edged tape fixed between two posts;

and

FIG. 14 is a perspective view of a photoluminescent embodiment of the extruded smooth elastomer feather-edged tape wrapped around a compact fluorescent light bulb.

### DETAILED DESCRIPTION

The materials described herein are directed, in general, to extruded elastomer grip tapes and more specifically to extruded elastomer grip tapes with crenulated cleavages to improve grip and to reduce vibration transfer. Although embodiments of the present invention are disclosed herein, the disclosed embodiments are merely exemplary and it should be understood that the invention relates to many alternative forms, including different shapes and sizes. Furthermore, the Figures are not drawn to scale and some features may be exaggerated or minimized to show details of particular features while related elements may have been eliminated to prevent obscuring novel aspects. Therefore, specific structural and functional details disclosed herein are not to be interpreted as limiting but merely as a basis for the claims and as a representative basis for enabling someone skilled in the art to employ the present invention in a variety of manners.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

As used herein, the terms “about” and “approximately”, when used in conjunction with ranges of dimensions, compositions of mixtures or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

As used herein the phrase “crenulated” or “crenulated elastomer tape” refers to the elastomer material having irregular wavy ridges or foliations on one or both sides of the tape with feathered edges in which the thickness of the tape decreases from a maximum thickness down the middle of the tape but tapers off in the transverse direction to very thin edges.

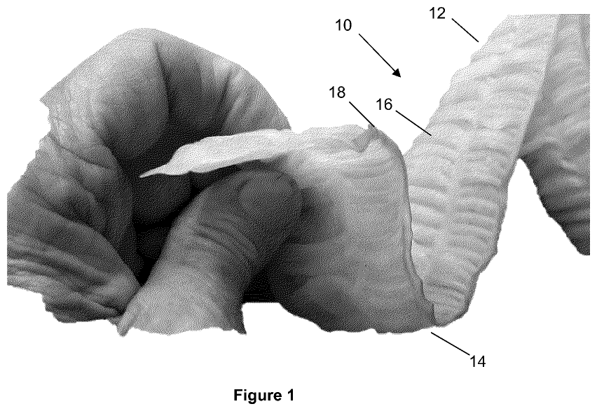

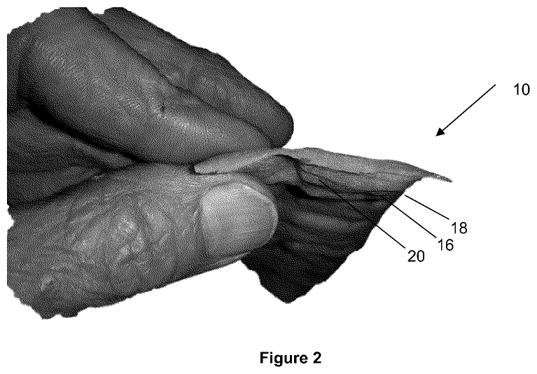

The extruded elastomer grip tape of the present disclosure, an embodiment of which is shown in FIG. 1 at 10, generally comprises a first side 12 and an opposed second side 14. The tape 10 has non-uniform crenelated cleavages 16 extending transversely along the tape 10 and the edges between the first side 12 and second side 14 are feather-edges 18 which taper from the maximum thickness of tape 10 to very thin edges 18 such that the edges 18 are flush with any object the tape 10 is applied to. The feather-edges 18 are curved such that both feather-edges 18 on both sides of the tape 10 are curved toward one of the first side 12 or the second side 14. FIG. 2 is a close-up view of tape 10, which clearly shows small ridges 20. The crenulated cleavages 16 and ridges 20 give the tape 10 a relatively large surface area for its length compared to an uncrenulated tape of the same width and length.

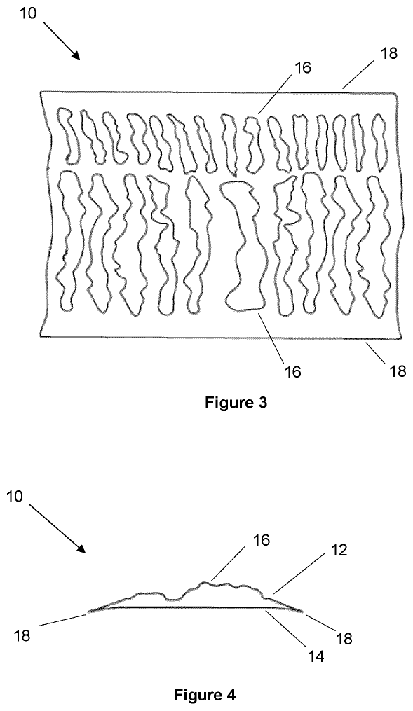

A top view of the crenulated tape 10 is shown in FIG. 3, which clearly shows the non-uniformity of the crenulated cleavages 16.

The curved shape of the crenulated tape 10 is shown in FIG. 4, which is a cross sectional view of tape 10 across its width, where first side 12 is convex and second side 14 is concave.

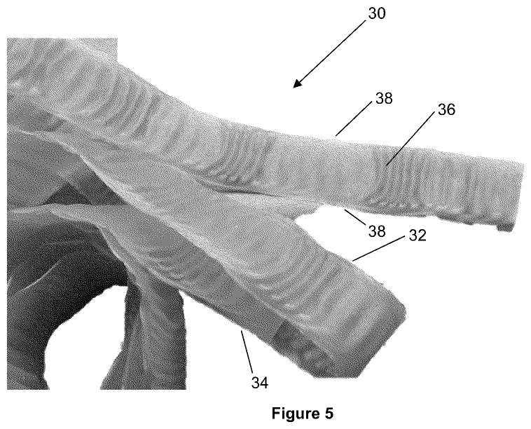

An alternative embodiment of a crenulated tape is shown generally at 30 in FIG. 5. Tape 30 is similar to tape 10 of FIG. 1 as it has a first side 32 and a second side 34 where the tape 30 has crenulated cleavages 36 and feather-edges 38, which are similar to that of tape 10. The difference between tape 30 and tape 10 is that tape 30 has higher ridges on crenulated cleavages 36. The size, height and depth of the crenulations can be regulated by the extruder and take off settings as well as materials used.

Another alternative embodiment of the extruded elastomer grip tape of the present disclosure may contain a phosphorescent material which improves the visibility of the tape in dark environments. Adding phosphorescent material or photoluminescent pigments to the elastomer results in light emission for up to 20 hours. The phosphor colors may include light yellow, light green, light white, red, orange, green and blue. The above-mentioned phosphorescent pigments are non-toxic, non-radioactive, and consist of alkaline aluminate, activated by rare earth ions. This feature is compatible with all embodiments of the tape disclosed herein.

The addition of a small amount of fluorescent material significantly enhances the brightness of light emission, particularly under poor, but not dark light conditions. This feature is compatible with all embodiments of the tape disclosed herein.

Another alternative embodiment of the extruded elastomer grip tape of the present disclosure may include a small percentage of “glitter niblets”, which are small flakes of reflective material bound to the surface of the tape, which gives the tape a reflective characteristic. In a specific embodiment of the extruded elastomer grip tape, the tape may contain aluminum glitter niblets. One skilled in the art will appreciate that reflective plastic particles, other metal flakes or any other reflective material may be incorporated into the tape. This feature is compatible with all embodiments of the crenulated tape disclosed herein.

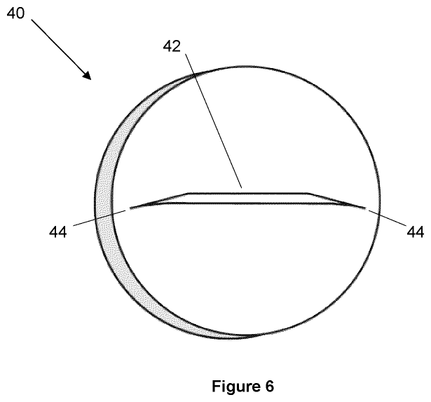

The extruded elastomer grip tape of the present disclosure is manufactured by extrusion of an elastomer in a durometer range of Shore 35-A to 90-A, regulated through a die 40, shown in FIG. 6 by set speed on the extruder made with specific elastomers of thermoplastic and/or rubber blends. Elastomeric materials with different hardnesses are observed to produce different results. Extrusion speeds, material durometer and temperatures control the size and spacing of the crenulated cleavages and small ridges. The die 40 used to extrude the extruded elastomer grip tape of the present disclosure is shown in detail in FIG. 6. Die 40 has an elongate slit or aperture 42 through which the elastomer is extruded. The slit 42 narrows laterally across the dye to produce feather-edges 44 causing the tape which is extruded through the die 40 to have thin feather-edges 18 (FIG. 1) and 38 (FIG. 5). FIG. 6 clearly shows feather-edges 44 being curved toward one side of the hole 42.

The tape is formed using an extruder able to extrude an elastomer wherein the speed of extrusion and temperature of extrusion are controlled. The extrusion speed and temperature may also be controlled. The tape produced by extruding elastomer through the die 40 using the extruder, while controlling the speed of extrusion and temperature of extrusion and the take-off speed such that the elastomer vibrates while being extruded through the die 40 with feather-edges 44. This process extrudes an elastomer tape with feather-edges and crenulated cleavages, the crenulated cleavages form due to the vibrations of the elastomer while being extruded through the die 40. In a non-limiting example, the degree of crenulation may be controlled by varying the processing parameters during extrusion such as the aforementioned controlling the speed of extrusion and temperature of extrusion and the take-off speed to vary the amount of vibration and hence degree of crenulation.

A smooth elastomer feather-edged crenulated tape may also be produced using the above-mentioned process, but where the speed of extrusion and temperature of extrusion are configured such that a smooth non-crenulated elastomer feather-edged tape is produced.

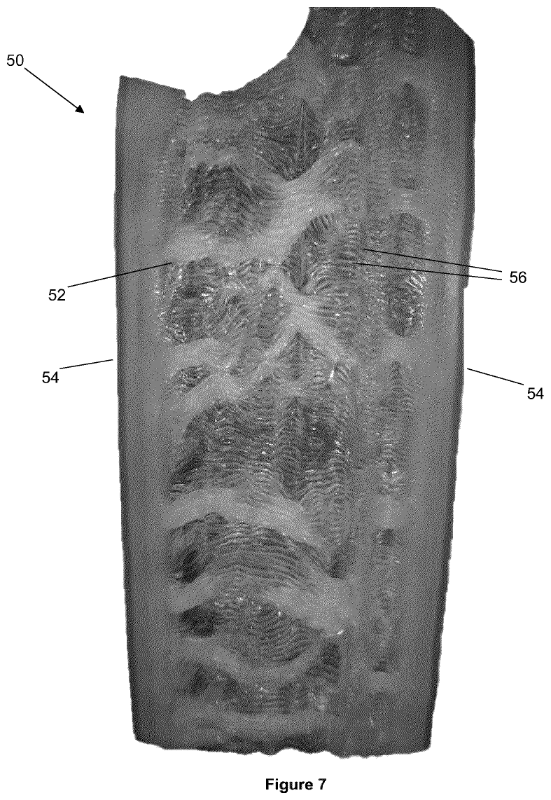

The variation in the properties of the extruded elastomer grip tape of the present disclosure as a result of changes in material, extrusion speed and temperature is shown in the top view of FIG. 7, which shows an embodiment of extruded elastomer grip tape 50 which has extruded from the same die as the tape 10 but the extrusion process parameters, material, extrusion speed and temperature are different. The tape 50 has crenulated cleavages 52, feather-edges 54 and small ridges 56, similar to that of tape 10, but the size and pattern of these features are different. The die through which the elastomer tape with crenulated cleavages is extruded can also extrude smooth elastomer feather-edged tape as noted above.

While the present crenulated tape has been disclosed above as being produced by extrusion, it will be understood it may also be produced using injection molding. Specifically one skilled in the art will appreciate that similar crenulated tapes with feather-edges may be produced using injection molding or blow molding using appropriate elastomers and moulds.

Polyurethane is a preferred thermoplastic material for production of the present crenulated tapes because of its durability and tensile strength, followed by a polyolefin or one of the six generic classes of commercial thermoplastic elastomers or thermoplastic rubber compounds such as Dynaflex® and Kraton®.

One skilled in the art will appreciate that all embodiments of the extruded elastomer grip tape of the present disclosure are recyclable. The extruded elastomer grip tape of the present disclosure may be wrapped around an object that is grasped by a person. The tape improves grip of an object due to the crenulated cleavages and ridges and the tape reduces vibration transferred from the object to the person grasping the object.

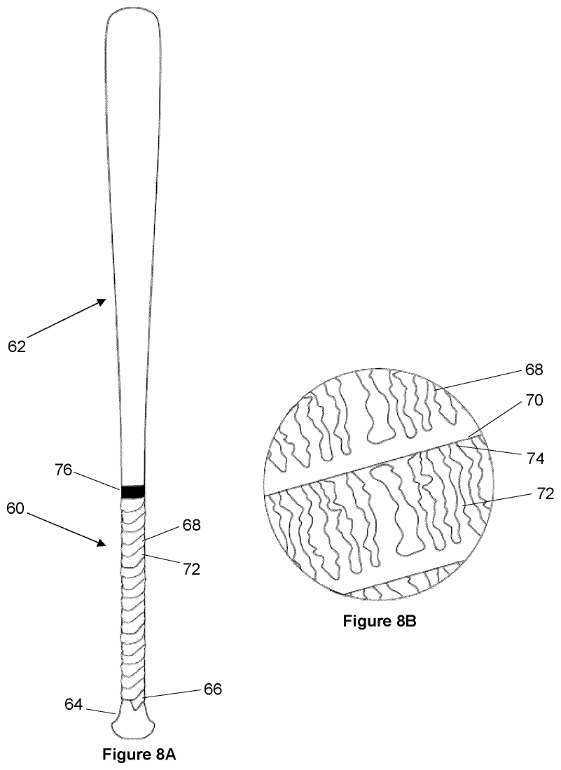

An example use of the extruded elastomer grip tape of the present disclosure being wrapped around an object is shown in FIG. 8A, wherein an embodiment of the tape 60 is wrapped around a baseball bat 62 to provide grip and to reduce vibration transfer. Tape 60 has the same features as tape 10. Due to the elasticity and excellent self-bonding properties of tape 60, adhesive is not needed along the length of the tape 60. The tape 60 is applied to the baseball bat handle 64 by wrapping the tape 60 around itself 66 such that the self-bonding properties of the tape prevent the tape from unwrapping. The tape 60 is then wrapped along the length of the bat handle 64 in a spiral, shown in detail in FIG. 8B under slight tension such that any given section of the tape 60, for example 68 has its feather-edged 70 in the direction of the preceding section 72, overlaps the feather-edged 74 nearest to section 68. The self-bonding of the tape 60 between overlapping feather-edges, for example feather-edges 70 and 74 enables the tape 60 to be tightly wrapped around the handle 64. The end of the tape 60 spiral must be fixed such that the tape 60 does not become unwrapped because there is no following section of tape to overlap with it. For example tape 60 is fixed at the end with adhesive tape 76, similar to the way that the grip on a tennis racket is fixed in place. The tape 60 reduces vibration transmitted between the bat 62 and a baseball player.

A further benefit of the extruded elastomer grip tape of the present disclosure is that the non-uniformity of the crenulated cleavages creates a unique and identifiable pattern of crenulated cleavages when wrapped around an object. For example, baseball players using a bat 62 with tape 60 wrapped around it have been able to identify where to grip the bat 62 based on the feeling of the grip in the player's hands. Specifically, the player may memorize the unique pattern of crenulated cleavages where he or she grips the bat 62.

Additionally, the tension in the extruded elastomer grip tape of the present disclosure when wrapped around an object will reinforce the object. The tension is approximately 5 to 25 lbs per wrap. With regard to the embodiment shown in FIGS. 8A and 8B, the tape 60 is wrapped tightly around the baseball bat 62, which is wood, such that the tape 60 exerts a force on the handle 64 directed radially from the tape 60 toward the central axis of the handle 64. This force reduces fracturing in the handle 64.

Additionally, when wrapped around an object, air pockets are formed between the crenulated cleavages and the object. With regard to FIG. 8A, there are air pockets between the crenulated cleavages and the handle 64 as well as the crenulated cleavages and a person's hand. These air pockets provide circulation which enables the extruded elastomer grip tape of the present disclosure to dissipate heat more efficiently compared to a flat tape of the same material and thickness, reducing sweating as well.

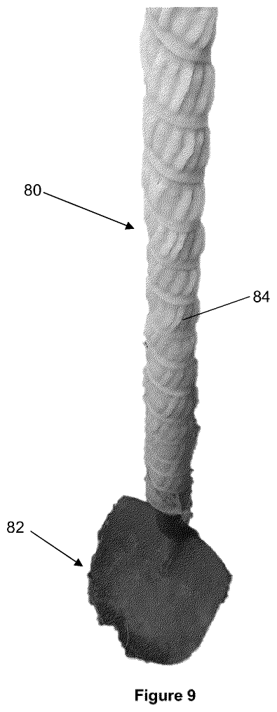

A further example of a use of the extruded elastomer grip tape of the present disclosure is shown in FIG. 9, wherein the tape 80 which has the same features as tape 10 is wrapped around the handle of a shovel 82. Tape 80 is wrapped around the shovel 82 in the same way as the tape 60 is wrapped around the baseball bat 62 as described in a preceding paragraph. The crenulated cleavages 84 are soft and elastic such that they may move relative to the handle when the shovel 82 is used, which reduces blistering and transferred vibrations. This is because blisters can be caused by friction against skin and when an object wrapped in the extruded elastomer grip tape, for example shovel 82, the crenulated cleavages 84 do not move relative to the shovel holder's hands and the crenulated cleavages 84 move relative to the shovel 82 handle, eliminating kinetic friction between the person's hand or hands and the shovel. This means that the person's hand or hands move relative to the shovel because the crenulated cleavages move relative to the shovel, but there is no kinetic friction or rubbing against the person's hand or hands because the person's hand or hands do not move relative to the crenulated cleavages. The relative motion between the crenulated cleavages 84 and the shovel 82 handle are influenced by the force of the shovel holder's grip because a stronger grip will press the crenulated cleavages 84 firmly against the shovel 82 handle which will increase friction between the crenulated cleavages 84 and the shovel handle 82 and reduce motion.

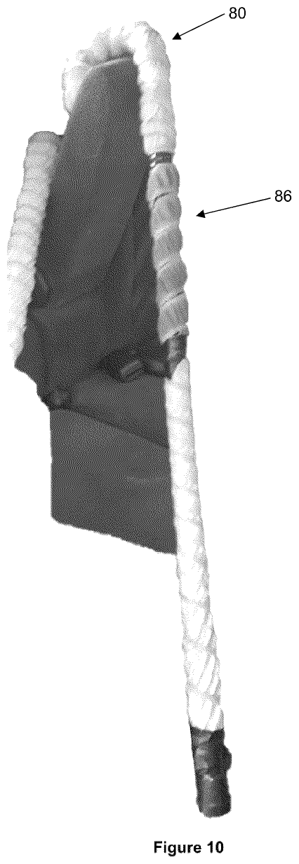

The blister reducing property of tape 80 is also applicable to walking aides such as canes and walkers, as shown in FIG. 10, where tape 80 is wrapped around cane 86. When a person walks with a cane, the person moves their hand relative to the handle as the person rotates their hand relative to the handle, which causes blisters.

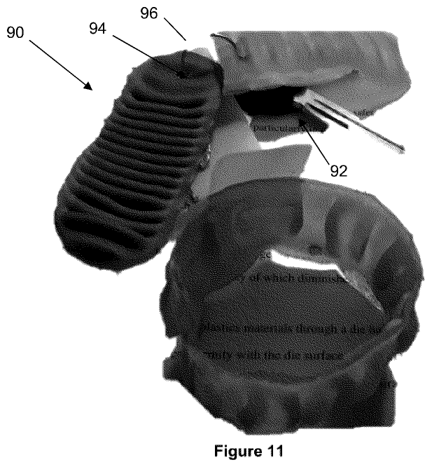

Another exemplary use of the extruded elastomer grip tape of the present disclosure is shown in FIG. 11, wherein a short piece of tape 90 which has the same features as tape 10, is used as a keychain for a key 92. The piece of tape 90 has a hole 94 that is attachable with a keyring 96. The piece of tape 90 enables a person to easily hold one or more keys. Also, a phosphorescent keychain embodiment allows a person to easily see the keychain in environments with poor light. The piece of tape 90 can also be used to grip a bottle cap or jar lid to aid in opening.

The extruded elastomer grip tape of the present disclosure in its flat grit-textured non-skid/non-slip version may also be fixed to flat surfaces using an adhesive like double-sided tape of a width slightly narrower than the feather-edged tape. The tape may be used to improve grip on flat surfaces and the feather-edges enable the tape to be fixed virtually seamlessly to the flat surface eliminating the possibility of the edge being peeled or curled up due to wear/use.

The extruded elastomer grip tape of the present disclosure may also be used as an indicator or marker. Specifically, crenulated cleavages provide an easily identifiable texture. Also, phosphorescent embodiments of the extruded elastomer grip tape of the present disclosure may be used as a visual indicator.

The extruded smooth elastomer feather-edged tape of the present disclosure is non-slip.

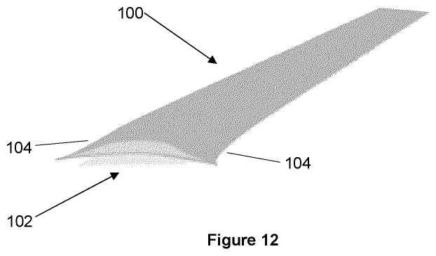

A phosphorescent embodiment of the extruded smooth elastomer feather-edged tape may be used as an indicator which can be applied to smooth surfaces such as floors and walls. The smooth elastomer feather-edged tape may be fixed to a surface using an adhesive material such as double-sided tape or caulking. The curved profile of the feather-edges forms a virtually waterproof seal around the adhesive. The feather-edges are also flush with the surface such that objects moving along the surface do not catch on the edge and damage the tape or the adhesive bond. FIG. 12 shows extruded smooth elastomer feather-edged tape 100 with feather-edges 104 being fixed to a floor with double sided tape 102. For example, when used to mark floors, footwear will not damage the smooth elastomer feather-edged tape because footwear is not able to catch on the edge of the tape and damage it.

The tape may also be fixed to flat surfaces with fasteners such as screws. In an exemplary use, a phosphorescent embodiment of the extruded smooth elastomer feather-edged tape is fixed to a wooden dock using two screws, one at each end of the length of tape. The tape is first screwed to the dock at one end then it is screwed to the dock at the other end such that the tape is taught and follows a straight line between the two screws.

A phosphorescent embodiment of the extruded smooth elastomer feather-edged tape may also be used as an indicator which can be strung between two posts such that the tape forms a taught streamer between the two posts. The feather-edges of the tape have interesting aerodynamic properties such that airflow over the tape interacts with the feather-edges which causes the tape to twist, increasing elastic potential energy in the tape, until the airflow cannot further twist the tape. When the airflow is unable to further twist the tape, the tape untwists and then the airflow will twist the tape in the opposite direction of rotation. This twisting and the phosphorescent properties of the tape result in an indicator which is easily visible. One specific exemplary use of the tape as a twisting indicator is as a driveway marker, shown in FIG. 13 where tape 110 is suspended between posts 112 and 114.

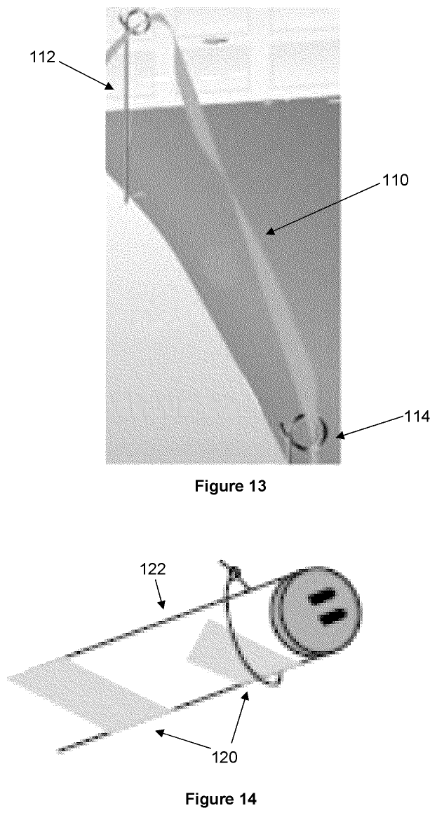

A phosphorescent embodiment of the extruded smooth elastomer feather-edged tape may also be used as an emergency light source, as shown in FIG. 14 where the tape 120 is wrapped around a compact fluorescent light bulb 122 such that the light energy from the light bulb 122 is stored in the phosphorescent material in the tape 120. If the light bulb 122 is turned off due to a power outage, the tape 120 emits sufficient light for a person to perform vision requiring activities in the vicinity of the light bulb 122.

In summary, in an embodiment, the present disclosure provides an extruded crenulated elastomer tape, comprising a tape composed of an elastomer extruded from a die having an elongate slit which tapers down to feathered edges, the tape having a first side and a second side opposite to the first side; wherein the tape has crenulated cleavages extending along the width of the tape, and wherein the tape has feather-edges thinner than a middle portion of the tape.

In an embodiment the present disclosure provides a method for extruding a crenulated elastomer tape, crenulated elastomer tape comprising: an elastomer, an extruder able to extrude at least one elastomer, the extruder being configured such that the speed of extrusion and temperature of extrusion are controllable, a die with a hole able to extrude an elastomer, and hole being shaped to extrude a tape with feather-edges. The method comprising the steps of: extruding said elastomer through the die using the extruder, while controlling the speed of extrusion and temperature of extrusion such that said elastomer vibrates while being extruded such that a crenulated elastomer tape is extruded, said crenulated elastomer tape characterized by having crenulated cleavages extending along the width of said tape between said feather-edges.

In an embodiment the extrusion speed and said extrusion temperature of said extruder are controlled such that said extruder extrudes smooth feather-edged tape using the same die and elastomer.

In an embodiment the elastomer has a durometer between Shore 35-A and Shore 90-A.

In an embodiment the elastomer is one of polyurethane, a polyolefin or one of the six generic classes of commercial thermoplastic or thermorubber elastomers.

In an embodiment the tape has small ridges which extend along the width of the tape in the same general direction as the crenulated cleavages of different controlled dimensions.

In an embodiment the feather-edges on both sides of the tape are curved toward one of the first side or the second side.

In an embodiment the tape is attached to an object and a person grips said tape, the person's grip of the object increases compared to the object without the tape.

In an embodiment the tape is attached to an object and when a person grips the tape, the tape reduces vibration transfer between the object and the person's hand or hands.

In an embodiment the tape is attached to an object and a person grips can grip the tape, and the crenulated cleavages do not move relative to person's hand or hands and said crenulated cleavages move relative to the object.

In an embodiment the tape contains phosphorescence or photoluminescence material such that the tape is phosphorescent of photoluminescent.

In an embodiment the phosphorescent material is alkaline aluminate and rare earth ions.

In an embodiment the tape contains fluorescent material such that the tape is fluorescent.

In an embodiment the tape contains reflective particles such that said tape is reflective.

In an embodiment the reflective particles are aluminum flakes.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. An extruded crenulated elastomer tape, comprising:
a tape composed of an elastomer extruded from a die having an elongate slit which tapers down to feathered edges;
said tape having a first side and a second side opposite to said first side;
wherein said tape has crenulated cleavages extending along the width of said tape; and
wherein said tape has feather-edges thinner than a middle portion of the tape.

2. The extruded crenulated elastomer tape of claim 1 wherein said elastomer has a durometer between Shore 35-A and Shore 90-A.

3. The extruded crenulated elastomer tape of claim 1 wherein said elastomer is one of polyurethane, a polyolefin or one of the six generic classes of commercial thermoplastic or thermorubber elastomers.

4. The extruded crenulated elastomer tape of claim 1 wherein said tape has small ridges which extend along the width of the tape in the same general direction as said crenulated cleavages of different controlled dimensions.

5. The extruded crenulated elastomer tape of claim 1 wherein said feather-edges on both sides of said tape are curved toward one of said first side or said second side.

6. The extruded crenulated elastomer tape of claim 1 wherein said tape is attached to an object and a person grips said tape, said person's grip of said object increases compared to said object without said tape.

7. The extruded crenulated elastomer tape of claim 1 wherein said tape is attached to an object and a person grips said tape, said tape reduces vibration transfer between said object and said person's hand or hands.

8. The extruded crenulated elastomer tape of claim 1 wherein said tape is attached to an object and a person grips said tape, said crenulated cleavages do not move relative to said person's hand or hands and said crenulated cleavages move relative to said object.

9. The extruded crenulated elastomer tape of claim 1 wherein said tape contains phosphorescence or photoluminescence material such that said tape is phosphorescent of photoluminescent.

10. The extruded crenulated elastomer tape of claim 9 wherein said phosphorescent material is alkaline aluminate and rare earth ions.

11. The extruded crenulated elastomer tape of claim 1 wherein said tape contains fluorescent material such that said tape is fluorescent.

12. The extruded crenulated elastomer tape of claim 1 wherein said tape contains reflective particles such that said tape is reflective.

13. The extruded crenulated elastomer tape of claim 12 wherein said reflective particles are aluminum flakes.

14. A method for extruding a crenulated elastomer tape, crenulated elastomer tape comprising:
an elastomer;
an extruder able to extrude at least one elastomer;
said extruder being configured such that the speed of extrusion and temperature of extrusion are controllable;
a die with a hole able to extrude an elastomer;
said hole being shaped to extrude a tape with feather-edges;
said method comprising the steps of:
extruding said elastomer through said die using said extruder, while controlling the speed of extrusion and temperature of extrusion such that said elastomer vibrates while being extruded such that a crenulated elastomer tape is extruded, said crenulated elastomer tape characterized by having crenulated cleavages extending along the width of said tape between said feather-edges.

15. The method of claim 14, wherein said extrusion speed and said extrusion temperature of said extruder are controlled such that said extruder extrudes smooth feather-edged tape using the same die and elastomer.

16. The method of claim 14, wherein said elastomer has a durometer between Shore 35-A and Shore 90-A.

17. The method of claim 14, wherein said elastomer is any one of polyurethane, a polyolefin or one of the six generic classes of commercial thermoplastic or thermorubber elastomers.

18. The method of claim 14, wherein said tape has small ridges which extend along the width of the tape in the same general direction as said crenulated cleavages of different controlled dimensions.

19. The method of claim 14, wherein said feather-edges on both sides of said tape are curved toward one of said first side or said second side.

20. The method of claim 14, wherein said tape is attached to an object and a person grips said tape, said person's grip of said object increases compared to said object without said tape.

21. The method of claim 14, wherein said tape is attachable to an object and when a person grips said tape, said tape reduces vibration transfer between said object and said person's hand or hands.

22. The method of claim 14, wherein said tape is attached to an object and a person grips said tape, said crenulated cleavages do not move relative to said person's hand or hands and said crenulated cleavages move relative to said object.

23. The method of claim 14, wherein said elastomer is extruded with a phosphorescence or photoluminescence materials mixed therewith so that said tape contains phosphorescence or photoluminescence material such that said tape is phosphorescent of photoluminescent.

24. The method of claim 23, wherein said phosphorescent material is any one of alkaline aluminate and rare earth ions.

25. The method of claim 14, wherein said elastomer is extruded with a fluorescent material mixed therewith such that said tape contains fluorescent material s0 that said tape is fluorescent.

26. The method of claim 14, wherein said elastomer is extruded with reflective particles mixed therewith so that said tape contains reflective particles such that said tape is reflective.

27. The method of claim 26 wherein said reflective particles are aluminum flakes.
